(19) United States
(12) Patent Application Publication
(10) Pub. No.: US 2009/0234679 A1
(43) Pub. Date: Sep. 17, 2009

(54) System and a Method for Managing Tickets Sale for Sporting Events

(76) Inventors: Yaniv Ozana, Ashkelon (IL); Oren Tal, Ashkelon (IL)

Correspondence Address: The Law Office of Michael E. Kondoudis, PC, 888 16th Street, N.W., Suite 800, Washington, DC, 20006, US

(21) Appl. No.: 12/299,562

(22) PCT Filed: Apr. 26, 2007
(86) PCT No.: PCT/IL07/00513

§ 371 Date: Nov. 4, 2008

Related U.S. Application Data
(60) Provisional application No. 60/796,645, filed on May 1, 2006.

(51) Int. Cl. G06Q 50/00; G06Q 10/00; G06Q 30/00

(52) U.S. Cl. 705/5; 705/400; 705/26

(57) ABSTRACT

The proposed solution enables a centralized sale of tickets to tournament final games to customers, while ensuring that fans of the finalists' teams are able to purchase the tickets at the prices of the tickets at the time of registration. The disclosed invention provides a computerized web-based service which serves both the sports fans and the organizations authorized to sell the tickets. The service enables fans to secure the option to purchase tickets to the final games of a tournament and to see their favorite team in action, provided that their team has made it through to the final games.

### FIELD OF THE INVENTION

The present invention relates in general to the field of systems and methods for managing sales of tickets for sports events; more particularly it relates to systems and methods for managing presales of tickets for games.

### BACKGROUND

One of the most common problems for fans of a particular sports group, such as a basketball or a soccer team participating in a tournament is the inability to know in advance whether or not their team would reach the finals. By the time the finalists are known, the tickets to the final game are sold out and fans have to over-pay for tickets from other buyers or to purchase last-minute tickets from ticket touts.

### SUMMARY OF SOME EMBODIMENTS OF THE INVENTION

Disclosed is a computerized method for purchasing tickets for sports events through a communication network, wherein the specific participants of the game are not determined during the time of the purchase. The method comprises the step of sending purchasing option request by at least one customer through the communication network. The request includes an identification of at least one favorable participant. The option request is offered by a central computing system to the customer at a price which is lower than the ticket price at that point in time. The method also enables the customers who ordered the relevant ticket options and selected a participant who reached the relevant sports event to purchase the tickets at the time of ordering price, once the participants of the sports events are determined.

The calculation of the option price optionally includes the step of determining the option price in accordance with intervening factors. The weight of each intervening factor in the option price is predetermined. The intervening factors optionally include the time period before the event, wherein the longer the time period the lower the option price. The intervening factors optionally also include the prospects of the favorable participant to take part in the event, wherein the higher the prospects are the higher the option price is. The intervening factors optionally also include the location of the requested seats.

Also disclosed is a computerized system for purchasing tickets for sports events through a communication network, wherein the specific participants of the game are not determined at the time of the purchase. The system comprises a first module for enabling customers to purchase ticket options to the sports events at a price which is lower than the ticket price at that point in time, wherein the customers specify at least one favorable participant, and a second module for enabling customers to buy the actual tickets to the sports events at the price determined at the time of purchasing the ticket options.

The first module optionally calculates the price of the ticket option in accordance with intervening factors. The weight of each intervening factor in the option price is optionally predetermined. The intervening factors optionally include the time period before the event, wherein the longer the time period the lower the option price. The intervening factors optionally also include the prospects of the favorable participant to take part in the event, wherein the higher the prospects are the higher the option price is. The intervening factors optionally also include the location of the requested seats.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is an illustration of the principal components of the system in accordance with some embodiments of the present invention;

FIG. 2 is a flowchart illustrating the procedure of purchasing a ticket in accordance with some embodiments of the present invention;

FIG. 3 is a table illustrating an example for ticket pricing of options according to team ranking and period during the season.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical elements.

### DESCRIPTION OF SOME EMBODIMENTS OF THE INVENTION

The present invention is a system and method which provide a solution to the above mentioned shortcoming of prior art. The proposed solution enables a centralized sale of tickets to tournament final games to customers, while ensuring that fans of the finalists' teams are able to purchase the tickets at the prices of the tickets at the time of registration. The disclosed invention provides a computerized web-based service which serves both the sports fans and the organizations authorized to sell the tickets. The service enables fans to secure the option to purchase tickets to the final games of a tournament and to see their favorite team in action, provided that their team has made it through to the final games.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

At the start of and during the season team fans are able to secure the option to purchase a ticket to the finals in standard ticket rates. According to one embodiment of the present invention customers may simply order the ticket options; according to other embodiments of the present invention customers are asked to pay for securing the ticket options. Provided that customers are requested to buy the ticket options, the price of the options should be lower than the stated value of the ticket itself and may be deduced from the price of the actual ticket when the ticket itself is purchased. The ability to secure ticket options is available before the identity of the finalists is determined. During the procedure of ordering the ticket options, customers inform the system which of the teams they support. If the team of the customer reaches the finals customers are able to exercise their option to purchase a ticket to the match. The tickets are then purchased at the stated price as set by the organizing body. The options of customers which support teams that did not reach the finals expire.

According to one embodiment of the present invention the price of all tickets may be determined a head of time and remain unchanged throughout the season. According to an additional embodiment of the present invention the price of the option and of the tickets may change according to predetermined criteria. These criteria may include, for instance, the period of time left before the finals and the estimated prospects of the indicated team to reach the finals, whereas the price of the ticket increases as the time of purchase is closer to the end of the season and as the chances of the team to reach the finals increase. Additionally, as customary in the field of tickets for sports events, option and ticket prices may also be determined according to type of seats and their location.

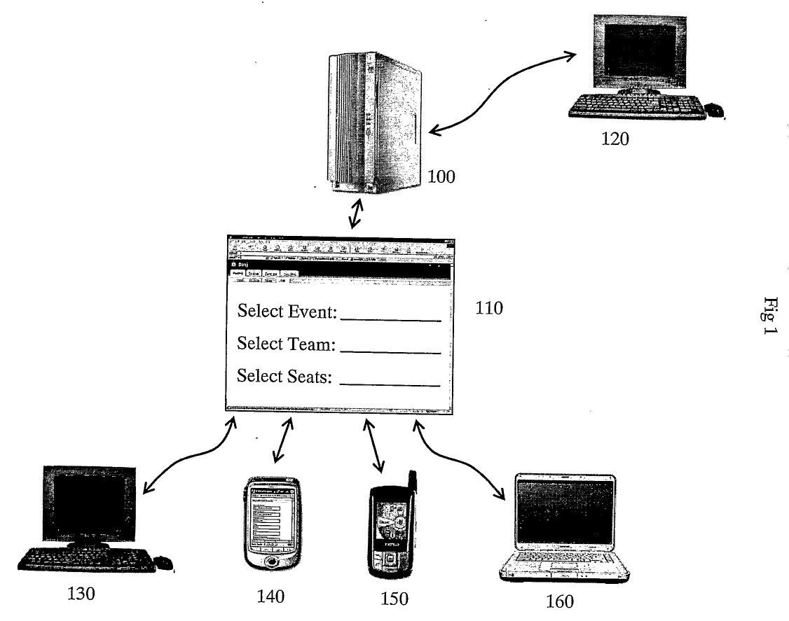

FIG. 1 is an illustration of the principal components of the system in accordance with some embodiments of the present invention. The system is comprised of a centralized computing unit 100, a user interface 120 and a web-based interface 110 from which customers may interact with the system. Customers may search for tickets, enquire about ticket prices, order ticket options and purchase the tickets using a plurality of devices, such as desktop 130 or laptop 160 computers, personal digital assistants (PDA) 140 or web-enabled cellular phone devices 150.

Through the user interface 120 the organization authorized to sell the tickets determines the types of available tickets, their price and quantity in addition to setting any other needed terms and criteria for ticket sales. This information is stored in the centralized computing unit 100 and processed by it. The processed data is then available for potential customers through the website interface 110. All activities performed by the customers through devices 130-160 in website 110 are reported back to the centralized computing center 100 and presented to the user through user interface 120.

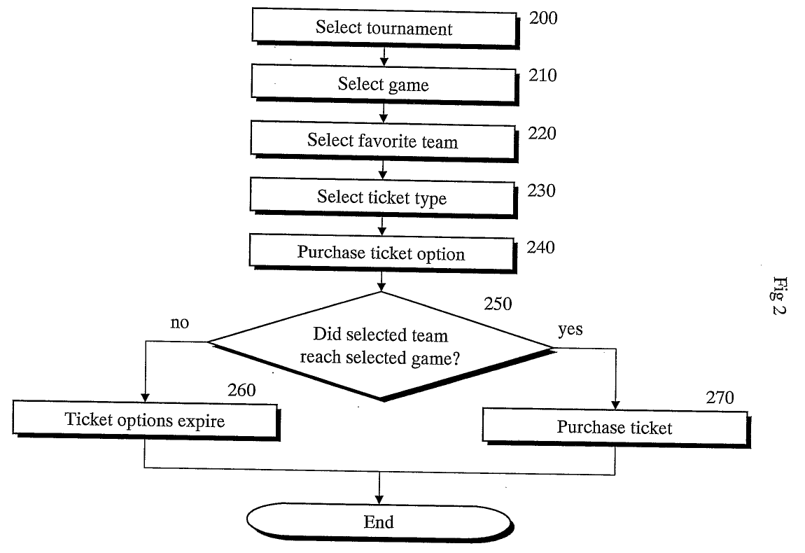

FIG. 2 is a flowchart illustrating the procedure of purchasing a ticket in accordance with some embodiments of the present invention. Entering the system customers are requested to select the tournament in which they wish to purchase a ticket (step 200). Such tournaments may include national leagues, such as the English football league or the American National Basketball Association (NBA) league, or an international league such as the Union of European Football Associations (UEFA) league or the Euroleague. Next customers are requested to select the desirable game, such as the semifinals or the finals (step 210) and indicate which team they wish to see (step 220). Then customers select the ticket type (step 230), according to ticket prices rating. Customers are then able to purchase the options to buy the tickets (step 240).

Once the season progresses and the identities of the teams participating in the final games are determined the system checks for the customers whether or not their teams are participating in the games they purchased the options for (step 250). Customers whose teams are participating in the final games can then purchase the tickets (step 270), while the ticket options of the customers whose teams did not reach this stage expire (step 260).

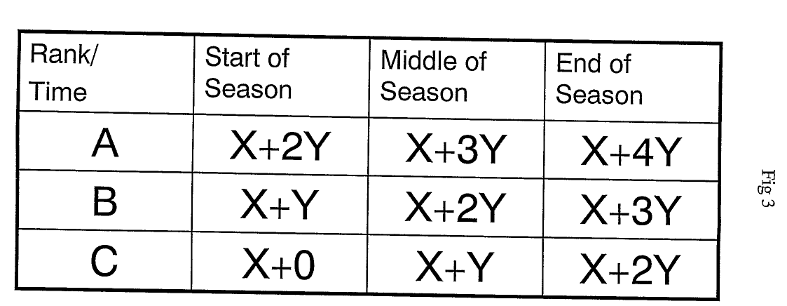

FIG. 3 is a table illustrating an example for ticket pricing of options according to team ranking and period during the season. In this example the teams participating in the tournament are ranked in one of three categories according to their estimated prospects of reaching the finals. This ranking may be determined according to expert opinion, according to records of achievements in previous seasons or a combination thereof. Teams which have the highest prospects are ranked in category A; category B includes teams which are less likely to reach the finals; and teams which have slim chances of reaching the finals are ranked in category C. As illustrated in the table of FIG. 3, at the opening of the season the ticket options for teams in category C are set to the basic price (X) and ticket options of teams in categories B and A are calculated accordingly. Ticket options of teams in category B are priced as X plus a predetermined sum (Y) and teams in category A are priced as X+2Y. As the season progresses the prices of ticket options of teams in all categories increase, each in relation to its original price. Thus, towards the end of the season the price of ticket options for teams in category A are equal to X+4Y, ticket options for teams in category B are equal to X+3Y and ticket options for teams in category C are equal to X+2Y. In all cases the price of the options remains lower then the ticket price itself.

According to another embodiment of the present invention the pricing of the tickets is performed according to the following formula:

<Option Price>=<Basic Price>*[(<Purchase Date Factor>*Weight₁)+(<Team Rating Factor>*Weight₂)+(<Seat Factor>*Weight₃)+(Factor₄*Weight₄)+(Factor₅*Weight₅)+ . . . +(Factorₙ*Weightₙ)]

Wherein Weight₁+Weight₂+ . . . +Weightₙ=1, and 0<=Factorᵢ<=1.

According to this formula the price of the option (Option Price) is determined according to the basic price of the ticket (Basic Price). In order to calculate the Option Price the Basic Price is multiplied by a combined calculation of different factors (Factor₁ . . . Factorₙ). Each factor is multiplied by a relative weight (Weight₁ . . . Weightₙ) which determines its influence on in the combination of factors. All factors range between 0 and 1 and the sum of all weights is 1, thus, the maximum value of the Option Price is the Basic Price. The combination of factors includes any list of elements which according to the type of sporting event should influence the Option Price. The list of factors and their relative weights are determined and fine tuned by the system administrator.

For instance, the date in which the customer purchases the ticket (Purchase Date Factor) can influence the Option Price whereas the more time there is before the event the lower the Option Price should be. Similarly, as described above, the chances of the team to participate in the event (Team Rating Factor) also influence the Option Price. Thus, the greater the chances of the team to take part in the event the higher the option price should be. As known in the art, the type of seat (Seat Factor) also influences Option Price. The list of factors can optionally include any other factors which can influence the Option Price.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

1. A computer implemented method for purchasing options for tickets for at least one sports game through at least one communication network, wherein the specific participants of the sports game are not determined at the time of the purchase, said method comprising:
sending a purchasing option request by at least one customer through the at least one communication network, wherein said request includes an identification of at least one favorable participant to be associated with said option:
offering said option at a price which is lower than a predefined face value of the ticket at that point in time, wherein said offering is carried out by a central computing system enabling to receive the requests and transmit associated options prices offers;
purchasing the options for game tickets, wherein the customer purchases the options for the game ticket according to his requests, wherein the request for purchasing an option is associated with the customer's favorable participant game; and
enabling said customers who purchased the relevant options and selected a favorable participant who reached the relevant sports game to purchase the game tickets at the original face value once the participants of said sports game are determined,
wherein the price of the option of each game, is changing in time according to the intervening factors that include the chances of a selected favorable participant to participate in the game at the time the option purchasing is requested, wherein the intervening factor is assigned to each purchasing request at each point in time, to allow calculating the option price at each point in time.

2. (canceled)

3. (canceled)

4. The method of claim 1, wherein said intervening factors include the time period before said game, wherein the longer the time period the lower the option price.

5. The method of claim 1, wherein said intervening factors include the prospects of said favorable participant to take part in said event, wherein the higher the prospects are the higher the option price is.

6. The method of claim 1, wherein said intervening factors include the location of the requested seats.

7. A computerized system for purchasing options for tickets for sports games through at least one communication network, wherein the specific participants of the sports game are not determined at the time of the purchase, said system comprising:
a first module for enabling customers to purchase ticket options to each sports game, specify at least one favorable participant associated with each game and each option, calculate the price of each option and present said calculated price;
a second module for enabling customers to buy the actual tickets to said sports games at the original face value of the game ticket
wherein the price of each option changes in time and is calculated at each point in time according to intervening factors that include the chances of the selected favorable participant to participate in the game at the time the option is purchased, wherein an intervening factor is assigned to each option purchasing request, to allow calculating the option price at each point in time.

8. The system of claim 7, wherein said first module calculates the price of each purchasing option, at each given time, according to the intervening factors.

9. The system of claim 8 wherein said the weight of each intervening factor in said option price is predetermined.

10. The system of claim 9, wherein said intervening factors include the time period before the sport game, wherein the longer the time period the lower the option price.

11. The system of claim 9 wherein said intervening factors include the prospects of said favorable participant to take part in said event, wherein the higher the prospects are the higher the option price is.

12. The system of claim 9 wherein said intervening factors include the location of the requested seats.
